(19) United States
(12) Patent Application Publication
(10) Pub. No.: US 2020/0065088 A1
(43) Pub. Date: Feb. 27, 2020

(54) DRIVE DEVICE AND DRIVE METHOD

(71) Applicants: HKC Corporation Limited; CHONGQING HKC OPOTOELECTRONICS TECHNOLOGY CO,.LTD, Chongqing (CN)

(72) Inventor: Wenqin ZHAO, Chongqing (CN)

(21) Appl. No.: 16/329,002

(22) PCT Filed: Oct. 31, 2018
(86) PCT No.: PCT/CN2018/112918

§ 371 Date: Feb. 27, 2019

(30) Foreign Application Priority Data
Aug. 27, 2018 (CN) 201810980999.9

(51) Int. Cl. G06F 8/654; G09G 3/00

(52) U.S. Cl. CPC G06F 8/654; G09G 2310/04; G09G 2330/021; G09G 3/006

(57) ABSTRACT

This application provides a drive device and a drive method. The drive device includes: an external memory, including: a memory, a signal detection circuit, a prompting pin, and a light-emitting prompting device. The signal detection circuit performs detection processing on data information in the memory.

### BACKGROUND

### Technical Field

This application relates to the display field, and in particular, to a device and method for driving a display device.

### Related Art

A thin film transistor-liquid crystal display (TFT-LCD) has advantages of low costs, low power consumption, and high performance, and is widely used in fields such as electronic and digital products. To drive a liquid crystal panel, a timing control integrated circuit (TCON IC) on a control board needs to send data information and control signals to a source driver and a gate driver. Because data in a static read-only memory (SROM) in the TCON IC cannot be stored after a power failure, timing control code (TCON code) of the TCON IC is stored in an external memory.

After being powered on, the TCON IC is initialized, and the TCON code is read from the external memory by using a bus. The external memory is provided with a write protection port WP, and the WP is high by default, and a write operation is forbidden. When a program needs to be updated, the WP is artificially pulled low. A write operation can be performed on the external memory only in this case.

When a program needs to be updated, a write operation is performed on the external memory. If an accidental power failure occurs when a new program is not completely written, and in addition, an original program in an electrically erasable programmable read only memory (EEPROM) or a flash memory is erased before a new program is written, an improved effect of the new program cannot be achieved, and a liquid crystal screen cannot be driven. To ensure correct programming, after programming is completed, a power failure and a power-on usually need to be performed before reading is performed once again. Consequently, the load of programming is increased, and the production efficiency is reduced.

### SUMMARY

To resolve the foregoing technical problem, an objective of this application is to provide a drive device, comprising: an external memory, comprising: a storage module, storing a program and verification information; a checking module, connected to the storage module; a prompting pin, connected to the checking module; and a prompting module, connected to the prompting pin, where the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal.

Another objective of this application is to provide a drive method, comprising: a drive method, comprising: disposing an external memory; disposing a storage module in the external memory, where the storage module stores a program and verification information; disposing a checking module in the external memory; disposing a prompting pin on the external memory; and disposing a prompting module, connected to the prompting pin, where the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal.

Still another objective of this application is to provide a drive device, comprising: an external memory, comprising: a storage module, comprising a plurality of registers, and storing a program and verification information; a checking module, connected to the storage module; a prompting pin, connected to the checking module; and a prompting module, connected to the prompting pin, where the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal; when performing the inspection processing, the checking module reads the data and the verification information in the storage module, the data in the storage module is values of the plurality of registers, the verification information is data preset in the program, and the checking module performs calculation processing on the data in the storage module, and compares a calculation result with the verification information; and when the calculation result is equal to the verification information and neither of them is zero, the checking module sends an instruction, the prompting pin outputs a first level to the prompting module, and the prompting module sends a first prompt signal; and when the calculation result is not equal to the verification information or at least one of them is zero, the prompting pin outputs a second level to the prompting module, and the prompting module sends a second prompt signal.

According to this application, whether a program is correctly programmed is verified, to avoid reading a programmed program once again to confirm whether the program is correctly programmed after programming each time, thereby improving the production efficiency.

### BRIEF DESCRIPTION OF THE DRAWINGS

FIG. 1 is a schematic structural diagram of an exemplary external memory;

FIG. 2a is a schematic structural diagram of an external memory according to an embodiment of this application;

FIG. 2b is a schematic structural diagram of an external memory according to an embodiment of this application; and

FIG. 3 is a flowchart of verification according to an embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe technical means used in this application to achieve a predetermined inventive objective and technical effects of this application, specific implementations, structures, features, and effects of a drive device and a drive method provided according to this application are described in detail below with reference to the accompanying drawings and specific embodiments.

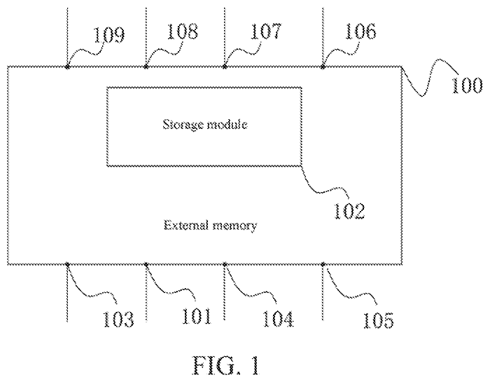

FIG. 1 is a schematic structural diagram of an exemplary external memory. Referring to FIG. 1, an exemplary drive device includes an external memory 100, including: a write protection port 101, a storage module 102, a grounding port 103, a chip select port 104, a holding port 105, a power supply interface 106, data input ports 107 and 108, and a clock control port 109. TCON code of a TCON IC (not shown) is stored in the external memory 100. After being powered on, the TCON IC is initialized, and the TCON code is read from the external memory 100 by using a bus (not shown). The external memory 100 is provided with a write protection port 101, and the write protection port 101 has a high level by default, and a write operation is forbidden. When a program needs to be updated, the write protection port 101 is artificially pulled low. A write operation can be performed on the external memory 100 only in this case. When a program needs to be updated, a write operation is performed on the external memory 100.

If an accidental power failure occurs when a new program is not completely written, and an original program in the external memory 100 is erased before a write operation, an improved effect of the new program cannot be achieved, and a liquid crystal screen cannot be driven. To ensure correct programming, after programming is completed, a power failure and a power-on are usually performed before reading is performed once again. Consequently, the load of programming is increased, and the production efficiency is reduced.

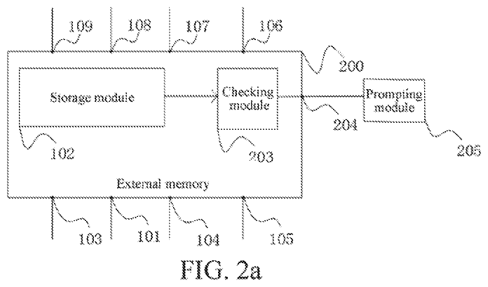

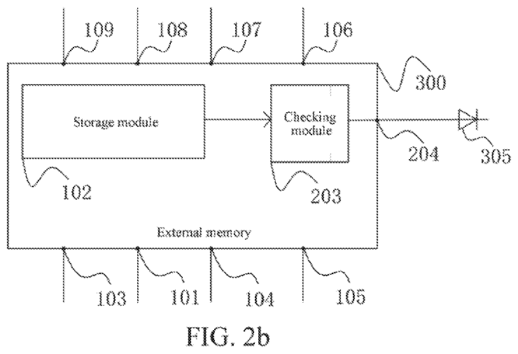

FIG. 2a is a schematic structural diagram of an external memory according to an embodiment of this application. Referring to FIG. 2a, in an embodiment of this application, a drive device includes: an external memory 200, including: a storage module 102, storing a program and verification information; a checking module 203, connected to the storage module 102; a prompting pin 204, connected to the checking module 203; and a prompting module 205, connected to the prompting pin 204, where the checking module 203 performs inspection processing on data and the verification information in the storage module 102, to obtain a result of the inspection processing, the checking module 203 controls the prompting pin 204 to output a level signal corresponding to the result of the inspection processing to the prompting module 205, and the prompting module 205 sends a corresponding prompt signal.

In an embodiment of this application, the external memory 200 is a flash memory. Like a read-write memory, data of the external memory 200 can be repeatedly read and written, and the data can also be kept for a long time without a current supply, and the price of the external memory 200 is low.

In an embodiment of this application, the storage module 102 includes a plurality of registers.

In an embodiment of this application, the checking module 203 is a signal detection circuit.

In an embodiment of this application, the checking module 203 is located in the external memory, and reads the data and the verification information in the storage module.

In an embodiment of this application, the data in the storage module 102 is values of the plurality of registers, and the verification information is data preset in the program.

In an embodiment of this application, each program corresponds to verification information included in the program, different programs correspond to different verification information, and it can be determined, by using verification information, whether a current program is a program corresponding to the verification information.

In an embodiment of this application, when performing inspection processing, the checking module 203 reads the data in the storage module 102 for calculation processing, and compares a calculation result with the verification information.

In an embodiment of this application, the prompting module 205 is a light-emitting prompting device, for example, a dual color light-emitting device.

In an embodiment of this application, the calculation result is equal to the verification information and neither of them is zero. The checking module 203 sends an instruction. The prompting pin 204 outputs a first level to the prompting module 205, so that the prompting module 205 emits green light as a first prompt signal, to prompt a user that programming succeeds.

In an embodiment of this application, the calculation result is not equal to the verification information, the prompting pin 204 outputs a second level to the prompting module, so that the prompting module 205 emits red light as a second prompt signal, to prompt a user that programming is abnormal.

In an embodiment of this application, referring to FIG. 2a, a drive method includes: disposing an external memory 200; disposing a storage module 102 in the external memory 200, where the storage module 102 includes a plurality of registers (not shown), and stores a program and verification information; disposing a checking module 203 in the external memory 200; disposing a prompting pin 204 on the external memory 200; and disposing a prompting module 205, connected to the prompting pin 204, where the checking module 203 performs inspection processing on data and the verification information in the storage module, to obtain a result of the inspection processing, the checking module 203 controls the prompting pin 204 to output a level signal corresponding to the result of the inspection processing to the prompting module 205, and the prompting module sends a corresponding prompt signal; when performing the inspection processing, the checking module 203 reads the data and the verification information in the storage module 102, the data in the storage module 102 is values of the plurality of registers, the verification information is data preset in the program, and the checking module performs calculation processing on the data in the storage module, and compares a calculation result with the verification information; and when the calculation result is equal to the verification information and neither of them is zero, the checking module 203 sends an instruction, the prompting pin 204 outputs a first level to the prompting module 205, and the prompting module 205 sends a first prompt signal; and when the calculation result is not equal to the verification information or at least one of them is zero, the prompting pin 204 outputs a second level to the prompting module 205, and the prompting module 205 sends a second prompt signal.

FIG. 2b is a schematic structural diagram of an external memory according to an embodiment of this application. Referring to FIG. 2b, in an embodiment of this application, a drive device includes: an external memory 300, including: a storage module 102, including a plurality of registers (not shown), and storing a program and verification information; a checking module 203, connected to the storage module 102; a prompting pin 204, connected to the checking module 203; and a prompting module 305, connected to the prompting pin 204, where the checking module 203 performs inspection processing on data and the verification information in the storage module 102, to obtain a result of the inspection processing, the checking module 203 controls the prompting pin 204 to output a level signal corresponding to the result of the inspection processing to the prompting module 305, and the prompting module sends a corresponding prompt signal; when performing the inspection processing, the checking module 203 reads the data and the verification information in the storage module 102, the data in the storage module 102 is values of the plurality of registers, the verification information is data preset in the program, and the checking module performs calculation processing on the data in the storage module, and compares a calculation result with the verification information, and when the calculation result is equal to the verification information and neither of them is zero, the checking module 203 sends an instruction, the prompting pin 204 outputs a first level to the prompting module 305, and the prompting module 305 sends a first prompt signal; and when the calculation result is not equal to the verification information or at least one of them is zero, the prompting pin 204 outputs a second level to the prompting module 305, and the prompting module 305 sends a second prompt signal.

In an embodiment of this application, referring to FIG. 2b, the prompting module 305 is a small light-emitting diode.

In an embodiment of this application, referring to FIG. 2b, the external memory 300 is an EEPROM, which has characteristics that data is not lost after a power failure, and original data in the EEPROM can be erased and data can be completely written into the EEPROM.

In an embodiment of this application, referring to FIG. 2b, when a program is updated for a drive device, the program that needs to be updated is programmed into the external memory 300. This is the first-time write operation performed on the external memory 300. A power failure occurs during programming. In this case, an initial value of verification information in the checking module is 0, and a sum of values written into the registers is also calculated as 0. In this case, the sum is equal to the initial value of the verification information, but both of them are 0. The prompting pin 204 outputs a low level as a second level, and the prompting module 305 keeps a switched-off (does not emit light) state, and prompts that the programming is abnormal.

In an embodiment of this application, referring to FIG. 2b, when a program is updated for a drive device, the program that needs to be updated is programmed into the external memory 300. This is not the first-time write operation performed on the external memory 300. A power failure occurs when original data is erased during programming. In this case, a value of verification information in the checking module 203 is a value of verification information of a previous program, and a sum of values written into the registers of this program is calculated as 0, which is not equal to the initial value of the verification information. In this case, the prompting pin 204 outputs a low level as a second level, and the prompting module 305 keeps a switched-off (does not emit light) state, and prompts that the programming is abnormal.

In an embodiment of this application, referring to FIG. 2b, when a program is updated for a drive device, the program that needs to be updated is programmed into the external memory 300. During programming, a power failure occurs when new data is written. In this case, verification information of the checking module 203 is verification information of the new program written in this write operation. After the write operation is stopped, a sum of values written into the registers this time is calculated, and then is compared with an initial value of the verification information of the checking module 203. In this case, the sum is not equal to the value of the verification information. The prompting pin 204 outputs a low level as a second level, and the prompting module 305 keeps a switched-off state, and prompts that the programming is not successful.

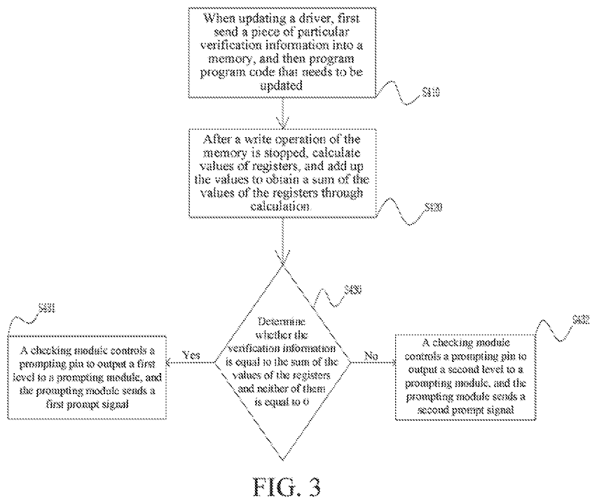

FIG. 3 is a flowchart of verification according to an embodiment of this application. Referring to FIG. 3, in an embodiment of this application, steps for verifying programming on a drive device are as follows:

Step S410: When updating a driver, first send a piece of particular verification information into a memory, and then program program code that needs to be updated.

Step S420: After a write operation of the memory is stopped, calculate values of registers, and add up the values to obtain a sum of the values of the registers through calculation.

Step S430: Determine whether the verification information is equal to the sum of the values of the registers and neither of them is equal to 0; if the verification information is equal to the sum of the values of the registers and neither of them is equal to 0, proceed to step S431, and otherwise, proceed to step S432.

Step S431: A checking module controls a prompting pin to output a first level to a prompting module, and the prompting module sends a first prompt signal, to prompt that programming succeeds.

Step S432: A checking module controls a prompting pin to output a second level to a prompting module, and the prompting module sends a second prompt signal, to prompt that programming is invalid.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

The foregoing descriptions are merely embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A drive device, comprising:
an external memory, comprising:
a storage module, storing a program and verification information;
a checking module, connected to the storage module;
a prompting pin, connected to the checking module; and
a prompting module, connected to the prompting pin, wherein
the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal.

2. The drive device according to claim 1, wherein the external memory is a non-volatile memory.

3. The drive device according to claim 1, wherein the storage module comprises a plurality of registers.

4. The drive device according to claim 1, wherein the checking module is a signal detection circuit.

5. The drive device according to claim 1, wherein the checking module is located in the external memory, and reads the data and the verification information in the storage module.

6. The drive device according to claim 1, wherein the prompting module is a dual color light-emitting device.

7. The drive device according to claim 3, wherein the data in the storage module is values of the plurality of registers, and the verification information is data preset in the program.

8. The drive device according to claim 4, wherein in the inspection processing, the checking module reads the data in the storage module for calculation processing, and compares a calculation result with the verification information.

9. The drive device according to claim 5, wherein each program corresponds to verification information comprised in the program, different programs correspond to different verification information, and it can be determined, by using verification information, whether a current program is a program corresponding to the verification information.

10. The drive device according to claim 8, wherein in the calculation processing, the data in the storage module is added up.

11. The drive device according to claim 8, wherein in the inspection processing, when the calculation result is equal to the verification information and neither of them is zero, the checking module sends an instruction, the prompting pin outputs a first level to the prompting module, and the prompting module sends a first prompt signal.

12. The drive device according to claim 8, wherein in the inspection processing, when the calculation result is not equal to the verification information or at least one of them is zero, the checking module sends an instruction, the prompting pin outputs a second level to the prompting module, and the prompting module sends a second prompt signal.

13. A drive method, comprising:
disposing an external memory;
disposing a storage module in the external memory, wherein the storage module comprises a plurality of registers, and stores a program and verification information;
disposing a checking module in the external memory;
disposing a prompting pin on the external memory; and
disposing a prompting module, connected to the prompting pin, wherein
the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal;
when performing the inspection processing, the checking module reads the data and the verification information in the storage module, the data in the storage module is values of the plurality of registers, the verification information is data preset in the program, and the checking module performs calculation processing on the data in the storage module, and compares a calculation result with the verification information; and
when the calculation result is equal to the verification information and neither of them is zero, the checking module sends an instruction, the prompting pin outputs a first level to the prompting module, and the prompting module sends a first prompt signal; and when the calculation result is not equal to the verification information or at least one of them is zero, the prompting pin outputs a second level to the prompting module, and the prompting module sends a second prompt signal.

14. The drive method according to claim 13, wherein the external memory is a non-volatile memory.

15. The drive method according to claim 13, wherein each program corresponds to verification information comprised in the program, different programs correspond to different verification information, and it can be determined, by using verification information, whether a current program is a program corresponding to the verification information.

16. The drive method according to claim 13, wherein in the calculation processing, the data in the storage module is added up.

17. A drive device, comprising:
an external memory, comprising:
a storage module, comprising a plurality of registers, and storing a program and verification information;
a checking module, connected to the storage module;
a prompting pin, connected to the checking module; and
a prompting module, connected to the prompting pin, wherein
the checking module performs inspection processing on data and the verification information in the storage module, to obtain a result of the inspection processing, the checking module controls the prompting pin to output a level signal corresponding to the result of the inspection processing to the prompting module, and the prompting module sends a corresponding prompt signal;
when performing the inspection processing, the checking module reads the data and the verification information in the storage module, the data in the storage module is values of the plurality of registers, the verification information is data preset in the program, and the checking module performs calculation processing on the data in the storage module, and compares a calculation result with the verification information; and
when the calculation result is equal to the verification information and neither of them is zero, the checking module sends an instruction, the prompting pin outputs a first level to the prompting module, and the prompting module sends a first prompt signal; and when the calculation result is not equal to the verification information or at least one of them is zero, the prompting pin outputs a second level to the prompting module, and the prompting module sends a second prompt signal.

18. The drive method according to claim 17, wherein the external memory is a non-volatile memory.

19. The drive method according to claim 17, wherein the checking module is a signal detection circuit.

20. The drive device according to claim 17, wherein the prompting module is a light-emitting prompting device.
